(19) United States
(12) Patent Application Publication
(10) Pub. No.: US 2016/0112526 A1
(43) Pub. Date: Apr. 21, 2016

(54) METHOD AND APPARATUS FOR OUTPUTTING NOTIFICATION EVENT

(71) Applicant: Samsung Electronics Co., Ltd., Suwon-si (KR)

(72) Inventors: Jun-Ki JEONG, Daegu (KR); Sang-Hyuk KOH, Jeju-si (KR); Dae-Yun KIM, Suwon-si (KR); Eun-Ju KIM, Seoul (KR); Jeong-Hoon KIM, Gumi-si (KR); Eun-Kyung YUN, Seoul (KR); Hye-Soon JEONG, Chilgok-gun (KR); Hyun-Suk CHOI, Daegu (KR); Dae-Sik HWANG, Daegu (KR)

(21) Appl. No.: 14/919,050

(22) Filed: Oct. 21, 2015

(30) Foreign Application Priority Data
Oct. 21, 2014 (KR) 10-2014-0142626

(51) Int. Cl. H04L 29/08

(52) U.S. Cl. CPC H04L 67/26; H04L 67/10

(57) ABSTRACT

An electronic device is provided. The electronic device includes a receiving module configured to receive the notification event from an object and a processor configured to identify the receipt of the notification event, create attribute information based on the information provided by the object, configure background information of the notification event by using the attribute information, and to output the background information of the notification event.

### CROSS-REFERENCE TO RELATED APPLICATION(S)

This application claims the benefit under 35 U.S.C. §119(a) of a Korean patent application filed on Oct. 21, 2014 in the Korean Intellectual Property Office and assigned Serial number 10-2014-0142626, the entire disclosure of which is hereby incorporated by reference.

### TECHNICAL FIELD

The present disclosure relates to a method and an apparatus for outputting notification events.

### BACKGROUND

Notification refers to an event by which the user is notified of a specified time or messages that are received from a system. The notification events may include alarms, schedules, incoming calls, short message services (SMSs), voice mails, or the like. If the notification event occurs, the electronic device may inform the user of the reception of the notification event by using an output method that can be recognized by the user (a text, a pop-up icon, a light emitting diode (LED) flashing, vibration feedback, or sound feedback).

The above information is presented as background information only to assist with an understanding of the present disclosure. No determination has been made, and no assertion is made, as to whether any of the above might be applicable as prior art with regard to the present disclosure.

### SUMMARY

In the case where the user is informed of the reception of the notification event by using a simplified output method, such as outputting text or an icon, outputting a vibration or a short sound, or light emitting diode (LED)-flashing, it is not possible for the user to intuitively recognize the type of notification event and the application that has sent the notification event.

Aspects of the present disclosure are to address at least the above-mentioned problems and/or disadvantages and to provide at least the advantages described below. Accordingly, an aspect of the present disclosure is to provide a notification event output method and an apparatus thereof, by which the user can intuitively recognize the type of notification event.

In accordance with an aspect of the present disclosure, an electronic device is provided. The electronic device includes a receiving module configured to receive the notification event from an object and a processor configured to identify the reception of the notification event, create attribute information based on the information provided by the object, configure background information of the notification event by using the attribute information, and output the background information of the notification event.

In accordance with another aspect of the present disclosure, a method of outputting a notification event in an electronic device is provided. The method includes receiving the notification event from an object that is related to the electronic device, identifying attribute information corresponding to the object based on the receipt of the notification event, and outputting background information of the notification event by using the attribute information through an output device that is functionally connected with the electronic device.

In accordance with another aspect of the present disclosure, an electronic device is provided. The electronic device includes a display, and a processor configured to identify a notification event for one or more applications that can be executed in the electronic device, obtain at least one piece of attribute information corresponding to the one or more applications or environment information of the electronic device based on the notification event, if the at least one piece of information is application information, output the first image via the display, and if the at least one piece of information is device information, output the second image via the display.

The notification event output method and the apparatus thereof, according to various embodiments of the present disclosure, can allow the user to intuitively recognize the type of notification event and the type of object that transmits the notification event.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment according to various embodiments of the present disclosure;

FIG. 2 is a block diagram of an electronic device according to various embodiments of the present disclosure;

FIG. 3 is a block diagram of a program module according to various embodiments of the present disclosure;

FIG. 4 is a block diagram of an electronic device for outputting a notification event according to various embodiments of the present disclosure;

FIGS. 5A, 5B, 5C, and 5D illustrate examples of background images of the notification event according to various embodiments of the present disclosure;

FIGS. 6A, 6B, 6C, and 6D illustrate examples of background effects of a notification event according to various embodiments of the present disclosure;

FIGS. 7A, 7B, 7C, 7D, 7E, 8A, 8B, 8C, 8D, 8E, 9A, 9B, 9C, 9D, and 9E illustrate examples of control operations of a background screen of a notification event according to various embodiments of the present disclosure;

FIG. 10 is a block diagram of a processing module according to various embodiments of the present disclosure;

FIG. 11 is a flowchart of a method for outputting a notification event based on reception of a notification event according to various embodiments of the present disclosure;

FIG. 12 is a flowchart of a method for outputting a notification event based on transmission of a notification event according to various embodiments of the present disclosure;

FIG. 13 is a flowchart of a method for outputting a notification event based on status information of a notification event according to various embodiments of the present disclosure; and

FIG. 14 is a flowchart of a method for outputting a notification event based on selection of a notification event according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

As used herein, the expression “have”, “may have”, “include”, or “may include” refers to the existence of a corresponding feature (e.g., numeral, function, operation, or constituent element such as component), and does not exclude one or more additional features.

As used herein, the expression “A or B”, “at least one of A and/or B”, or “one or more of A and/or B” may include any or all possible combinations of items enumerated together. For example, the expression “A or B”, “at least one of A and B”, or “at least one of A or B” may include (1) at least one A, (2) at least one B, or (3) both at least one A and at least one B.

The expression “a first”, “a second”, “the first”, or “the second” used in various embodiments of the present disclosure may modify various components regardless of the order and/or the importance but does not limit the corresponding components. The above expressions are used merely for the purpose of distinguishing an element from the other elements. For example, a first user device and a second user device indicate different user devices although both of them are user devices. For example, a first element may be termed a second element, and similarly, a second element may be termed a first element without departing from the scope of the present disclosure.

When it is mentioned that one element (e.g., a first element) is “(operatively or communicatively) coupled with/to or connected to” another element (e.g., a second element), it should be construed that the one element is directly connected to the another element or the one element is indirectly connected to the another element via yet another element (e.g., a third element). In contrast, it may be understood that when an element (e.g., first element) is referred to as being “directly connected” or “directly coupled” to another element (second element), there are no elements (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments of the present disclosure. Such terms as those defined in a generally used dictionary are to be interpreted to have the meanings equal to the contextual meanings in the relevant field of the art, and are not to be interpreted to have ideal or excessively formal meanings unless clearly defined in the present disclosure. In some cases, even the term defined in the present disclosure should not be interpreted to exclude various embodiments of the present disclosure.

For example, the electronic device may include at least one of a smartphone, a tablet personal computer (PC), a mobile phone, a video phone, an electronic book (e-book) reader, a desktop PC, a laptop PC, a netbook computer, a personal digital assistant (PDA), a portable multimedia player (PMP), a Moving Picture Experts Group phase 1 or phase 2 (MPEG-1 or MPEG-2) audio layer 3 (MP3) player, a mobile medical appliance, a camera, and a wearable device (e.g., a head-mounted-device (HMD) such as electronic glasses, electronic clothes, an electronic bracelet, an electronic necklace, an electronic appcessory, electronic tattoos, or a smart watch).

According to various embodiments of the present disclosure, the electronic device may be a smart home appliance. The home appliance may include at least one of, for example, a television (TV), a digital versatile disc (DVD) player, an audio player, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame.

According to an embodiment of the present disclosure, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic device for a ship (e.g., a navigation device for a ship, and a gyro-compass), avionics, security devices, an automotive head unit, a robot for a home or an industry, an automatic teller's machine (ATM) in banks, a point of sales (POS) in a shop, or an internet device of things (e.g., a light bulb, various sensors, electric or gas meter, a sprinkler device, a fire alarm, a thermostat, a streetlamp, a toaster, sporting goods, a hot water tank, a heater, a boiler, etc.).

According to various embodiments of the present disclosure, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to various embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments of the present disclosure will be described with reference to the accompanying drawings. As used herein, the term “user” may indicate a person who uses an electronic device or a device (e.g., an artificial intelligence electronic device) that uses an electronic device.

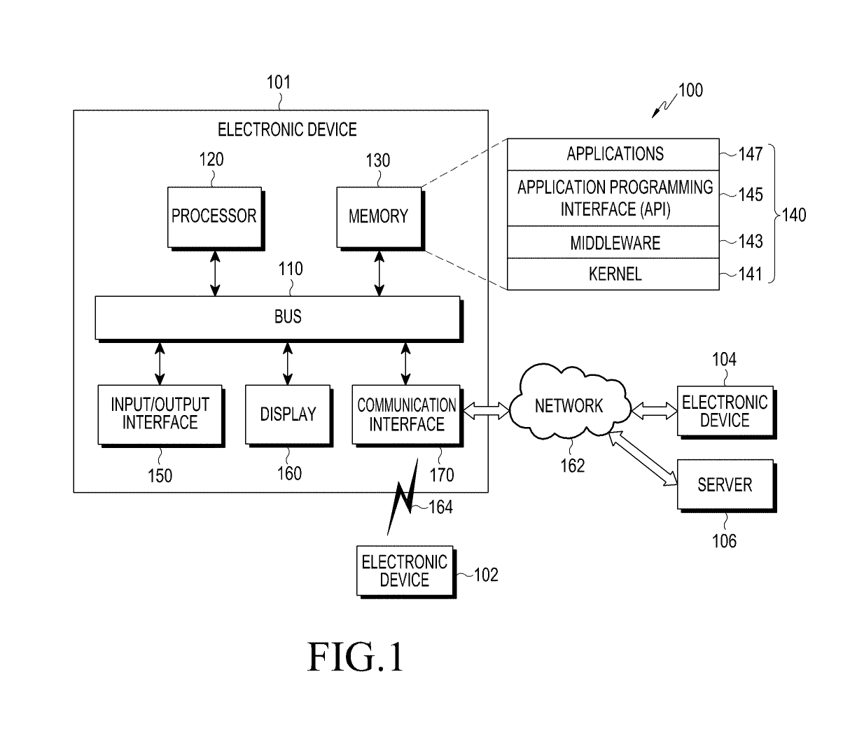

An electronic device 101 within a network environment 100, according to various embodiments of the present disclosure, will be described with reference to FIG. 1.

FIG. 1 illustrates a network environment according to various embodiments of the present disclosure.

Referring to FIG. 1, the electronic device 101 in the network environment 100 may include a bus 110, a processor 120, a memory 130, an input/output interface 150, a display 160, and a communication interface 170. In an embodiment of the present disclosure, the electronic device 101 may omit at least some of the above components or further include other components.

The bus 110 may include, for example, a circuit for connecting the elements 110 to 170 to each other and transferring communication (for example, a control message and/or data) between the elements.

The processor 120 may include one or more of a CPU, an AP, and a communication processor (CP). The processor 120 may control, for example, one or more other components of the electronic device 101 and/or process an operation or data related to communication.

Upon receiving a notification event, the processor 120 may output background information for the notification event based on attribution information corresponding to at least one application or at least one of device information and environment information, provided by the electronic device.

The memory 130 may include a volatile memory and/or a non-volatile memory. The memory 130 may store, for example, instructions or data related to at least one other component of the electronic device 101. According to an embodiment of the present disclosure, the memory 130 may store software and/or a program 140. The program 140 may include a kernel 141, middleware 143, an application programming interface (API) 145, and/or one or more application programs (or applications) 147. At least some of the kernel 141, the middleware 143, and the API 145 may be referred to as an operating system (OS).

For example, the kernel 141 may control or manage system resources (for example, the bus 110, the processor 120, and the memory 130) which are used to execute an operation or a function implemented in the other programs (for example, the middleware 143, the API 145, and the applications 147). Furthermore, the kernel 141 may provide an interface through which the middleware 143, the API 145, or the applications 147 may access individual components of the electronic device 101 to control or manage system resources.

For example, the middleware 143 may serve as a relay for allowing the API 145 or the applications 147 to communicate with the kernel 141 to exchange data. Furthermore, in regard to task requests received from the applications 147, the middleware 143 may perform a control (for example, scheduling or load balancing) for the task requests using, for example, a method of assigning a priority for using the system resources (for example, the bus 110, the processor 120, or the memory 130) to at least one application.

The API 145 is an interface by which the applications 147 control functions provided from the kernel 141 or the middleware 143, and may include, for example, at least one interface or function (for example, instructions) for file control, window control, image processing, or text control.

The input/output interface 150 may serve as an interface which can transmit commands or data input from the user or another external device to other components of the electronic device 101. Further, the input/output interface 150 may output commands or data received from another components of the electronic device 101 to the user or another external device.

The display 160 may include, for example, a liquid crystal display (LCD), a light emitting diode (LED) display, an organic LED (OLED) display, a micro electro mechanical system (MEMS) display, or an electronic paper display. The display 160 may display various types of contents (for example, text, images, videos, icons, or symbols) to users. The display 160 may include a touch screen, and may receive, for example, a touch, a gesture input, a proximity input, or a hovering input using an electronic pen or a user's body part.

The communication interface 170 may configure communication between, for example, the electronic device and an external device (for example, a first external electronic device 102, a second external electronic device 104, or a server 106). For example, the communication interface 170 may be connected to a network 162 through wireless or wired communication to communicate with the external device (for example, the external electronic device 104 or the server 106).

The wireless communication may use, for example, at least one of long term evolution (LTE), LTE-advanced (LTE-A), code division multiple access (CDMA), wideband CDMA (WCDMA), universal mobile telecommunications system (UMTS), wireless broadband (WiBro), and global system for mobile communications (GSM), for example, as a cellular communication protocol. The wired communication may include at least one of, for example, a universal serial bus (USB), a high definition multimedia interface (HDMI), recommended standard 232 (RS-232), and a plain old telephone service (POTS). The network 162 may include at least one of communication networks such as a computer network (for example, a local area network (LAN) or a wide area network (WAN)), the Internet, and a telephone network.

Each of the first and second external electronic devices 102 and 104 may be a device which is the same as or different from the electronic device 101. According to an embodiment of the present disclosure, the server 106 may include a group of one or more servers. According to various embodiments of the present disclosure, all or some operations performed in the electronic device 101 may be performed in another electronic device or a plurality of other electronic devices (e.g., the electronic devices 102, 104 or the server 106). According to an embodiment of the present disclosure, when the electronic device 101 should perform functions or services automatically or by a request, the electronic device 101 may request for performing at least some of the functions related to the functions or services to another device (for example, the electronic devices 102 and 104 or the server 106) instead of performing the functions or services by itself. Another electronic device (for example, the electronic devices 102 and 104 or the server 106) may execute the requested functions or additional functions, and transmit a result thereof to the electronic device 101. The electronic device 101 may provide the requested functions or services based on the received result as it is or after additionally processing the received result. To achieve this, for example, cloud computing, distributed computing, or client-server computing technology may be used.

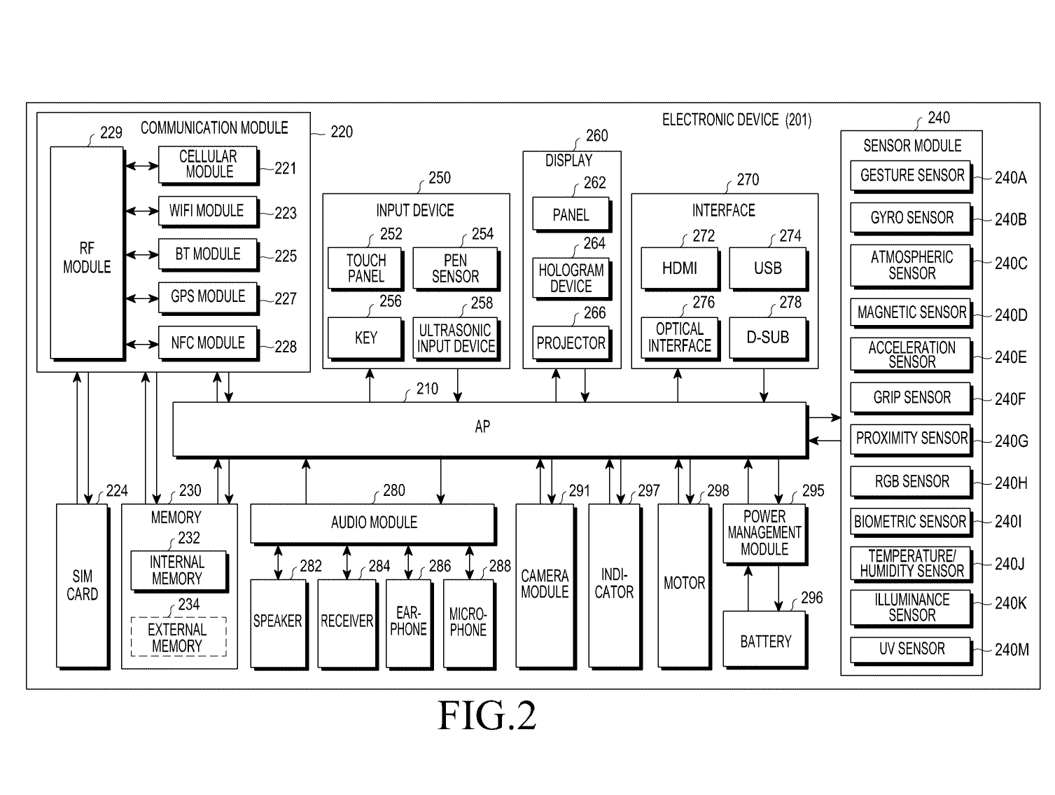

FIG. 2 is a block diagram illustrating a configuration of an electronic device according to various embodiments of the present disclosure.

Referring to FIG. 2, an electronic device 201 may include, for example, all or some of the electronic device 101 illustrated in FIG. 1. The electronic device 201 may include at least one AP 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The AP 210 may control a plurality of hardware or software components connected thereto by driving an OS or an application and perform a variety of data processing and calculations. The AP 210 may be embodied as, for example, a system on chip (SoC). According to an embodiment of the present disclosure, the AP 210 may further include a graphical processing unit (GPU) and/or an image signal processor. The AP 210 may include at least some of the components (for example, a cellular module 221) illustrated in FIG. 2. The AP 210 may load instructions or data, received from at least one other component (for example, a non-volatile memory), in a volatile memory to process the loaded instructions or data, and may store various types of data in a non-volatile memory.

The communication module 220 may have a configuration similar to the communication interface 160 of FIG. 1. The communication module 220 may include, for example, a cellular module 221, a wireless fidelity (Wi-Fi) module 223, a Bluetooth (BT) module 225, a GPS module 227, a near field communication (NFC) module 228, and a radio frequency (RF) module 229.

The cellular module 221 may provide a voice call, a video call, text message services, or Internet services through, for example, a communication network. According to an embodiment of the present disclosure, the cellular module 221 may distinguish between and authenticate electronic devices 201 within a communication network using a SIM (for example, the SIM card 224). According to an embodiment of the present disclosure, the cellular module 221 may perform at least some of the functions which may be provided by the AP 210. According to an embodiment of the present disclosure, the cellular module 221 may include a CP.

The Wi-Fi module 223, the BT module 225, the GPS module 227, and the NFC module 228 may include, for example, a processor for processing data transmitted/received through the corresponding module. According to an embodiment of the present disclosure, at least some (two or more) of the cellular module 221, the Wi-Fi module 223, the BT module 225, the GPS module 227, and the NFC module 228 may be included in one integrated chip (IC) or IC package.

The RF module 229 may transmit/receive, for example, a communication signal (for example, an RF signal). The RF module 229 may include, for example, a transceiver, a power amplifier module (PAM), a frequency filter, a low noise amplifier (LNA) or an antenna. According to an embodiment of the present disclosure, at least one of the cellular module 221, the Wi-Fi module 223, the BT module 225, the GPS module 227, and the NFC module 228 may transmit/receive an RF signal through a separate RF module.

The SIM card 224 may include a card including a SIM and/or an embedded SIM, and contain unique identification information (for example, an integrated circuit card identifier (ICCID)) or subscriber information (for example, an international mobile subscriber identity (IMSI)).

The memory 230 may include, for example, an internal memory 232 or an external memory 234. The internal memory 232 may include at least one of, for example, a volatile memory (for example, a dynamic random access memory (DRAM), a static RAM (SRAM), a synchronous DRAM (SDRAM), and the like) and a non-volatile memory (for example, a one time programmable read only memory (OTPROM), a PROM, an erasable and programmable ROM (EPROM), an electrically erasable and programmable ROM (EEPROM), a flash memory (for example, a NAND flash memory or a NOR flash memory), a hard driver, or a solid state drive (SSD).

The external memory 234 may further include a flash drive, for example, a compact flash (CF), a secure digital (SD), a micro-SD, a mini-SD, an extreme digital (xD), a memory stick, or the like. The external memory 234 may be functionally and/or physically connected to the electronic device 201 through various interfaces.

The sensor module 240 may measure a physical quantity or detect an operation state of the electronic device 201, and may convert the measured or detected information into an electrical signal. The sensor module 240 may include at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red/green/blue (RGB) sensor), a biometric sensor 240I, a temperature/humidity sensor 240J, an illumination sensor 240K, and an ultraviolet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an infrared (IR) sensor, an iris scanner, and/or a fingerprint sensor. The sensor module 240 may further include a control circuit for controlling at least one sensor included therein. In an embodiment of the present disclosure, the electronic device 201 may further include a processor configured to control the sensor module 240 as a part of or separately from the AP 210, and may control the sensor module 240 while the AP 210 is in a sleep state.

The input device 250 may include, for example, a touch panel 252, a (digital) pen sensor 254, a key 256, or an ultrasonic input device 258. The touch panel 252 may use at least one of, for example, a capacitive type, a resistive type, an infrared type, and an ultrasonic type. The touch panel 252 may further include a control circuit. The touch panel 252 may further include a tactile layer, and provide a tactile reaction to a user.

The (digital) pen sensor 254 may include, for example, a recognition sheet which is a part of the touch panel or a separate recognition sheet. The key 256 may include, for example, a physical button, an optical key or a keypad. The ultrasonic input device 258 may detect an acoustic wave using a microphone (for example, the microphone 288) through an input tool generating an ultrasonic signal to identify data.

The display 260 (for example, the display 160) may include a panel 262, a hologram device 264 or a projector 266. The panel 262 may include a component equal or similar to the display 160 of FIG. 1. The panel 262 may be embodied to be, for example, flexible, transparent, or wearable. The panel 262 may also be configured to be integrated with the touch panel 252 as a single module. The hologram device 264 may show a stereoscopic image in the air by using interference of light. The projector 266 may project light onto a screen to display an image. The screen may be located, for example, inside or outside the electronic device 201. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. The interface 270 may be included in, for example, the communication interface 160. Additionally or alternatively, the interface 270 may include, for example, a mobile high-definition link (MHL) interface, an SD card/multi-media card (MMC) interface, or an Infrared data association (IrDA) standard interface.

The audio module 280 may bilaterally convert, for example, a sound and an electrical signal. At least some components of the audio module 280 may be included in, for example, the input/output interface 140. The audio module 280 may process sound information input or output through, for example, a speaker 282, a receiver 284, earphones 286, the microphone 288, or the like.

The camera module 291 may photograph a still image and a dynamic image. According to an embodiment of the present disclosure, the camera module 291 may include one or more image sensors (for example, a front sensor or a back sensor), a lens, an image signal processor (ISP) or a flash (for example, LED or xenon lamp).

The power management module 295 may manage, for example, power of the electronic device 201. According to an embodiment of the present disclosure, the power management module 295 may include a power management IC (PMIC), a charger IC, or a battery or fuel gauge. The PMIC may have a wired and/or wireless charging scheme. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, the remaining amount of battery, a charging voltage, current, or temperature. The battery 296 may include, for example, a rechargeable battery and/or a solar battery.

The indicator 297 may show particular statuses of the electronic device 201 or a part (for example, AP 210) of the electronic device 201, for example, a booting status, a message status, a charging status and the like. The motor 298 may convert an electrical signal into mechanical vibrations, and may generate a vibration or haptic effect. Although not illustrated, the electronic device 201 may include a processing unit (for example, a GPU) for supporting mobile TV. The processing device for supporting mobile TV may process media data according to a standard of digital multimedia broadcasting (DMB), digital video broadcasting (DVB), media flow or the like.

Each of the components of the electronic device according to the present disclosure may be implemented by one or more components and the name of the corresponding component may vary depending on a type of the electronic device. In various embodiments of the present disclosure, the electronic device may include at least one of the above-described elements. Some of the above-described elements may be omitted from the electronic device, or the electronic device may further include additional elements. Further, some of the components of the electronic device according to the various embodiments of the present disclosure may be combined to form a single entity, and thus, may equivalently execute functions of the corresponding elements prior to the combination.

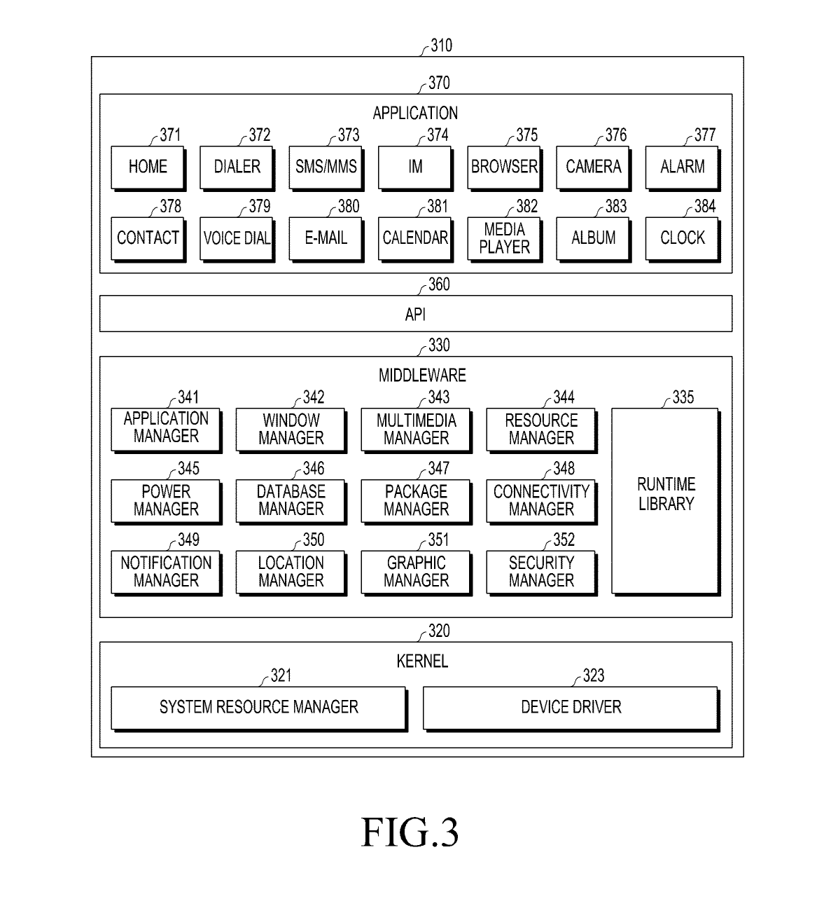

FIG. 3 is a block diagram of a program module according to various embodiments of the present disclosure.

Referring to FIG. 3, according to an embodiment of the present disclosure, the program module 310 (for example, the program 140) may include an OS for controlling resources related to the electronic device (for example, the electronic device 101) and/or various applications (for example, the applications 147) executed in the OS. The OS may be, for example, Android®, iOS®, Windows®, Symbian®, Tizen®, Bada®, or the like.

The programming module 310 may include a kernel 320, middleware 330, an API 360, and/or applications 370. At least some of the program module 310 may be preloaded in the electronic device or downloaded in the server (for example, the server 106).

The kernel 320 (for example, the kernel 141 of FIG. 1) may include, for example, a system resource manager 321 or a device driver 323. The system resource manager 321 may control, allocate, or collect the system resources. According to an embodiment of the present disclosure, the system resource manager 321 may include a process manager, a memory manager, or a file system manager. The device driver 323 may include, for example, a display driver, a camera driver, a BT driver, a shared-memory driver, a USB driver, a keypad driver, a Wi-Fi driver, an audio driver, or an inter-process communication (IPC) driver.

The middleware 330 may provide a function required by the applications 370 in common or provide various functions to the applications 370 through the API 360 so that the applications 370 may efficiently use limited system resources of the electronic device. According to an embodiment of the present disclosure, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The run time library 335 may include, for example, a library module that a compiler uses to add new functions through a programming language while the application 370 is executed. The run time library 335 may perform input/output management, memory management, or an arithmetic function.

The application manager 341 may manage, for example, a life cycle of at least one application among the applications 370. The window manager 342 may manage a graphical user interface (GUI) resource used in a screen. The multimedia manager 343 may detect a format required for reproducing various media files and encode or decode a media file using a codec appropriate for the corresponding format. The resource manager 344 may manage resources such as a source code, a memory or a storage space of at one of the applications 370.

The power manager 345 may operate together with, for example, a basic input/output system (BIOS) to manage a battery or power and may provide power information required for the operation of the electronic device. The database manager 346 may generate, search for, or change a database used by at least one of the applications 370. The package manager 347 may manage the installation or updating of applications distributed in the form of a package file.

For example, the connectivity manager 348 may manage wireless connections, such as Wi-Fi or BT. The notification manager 349 may display or notify of an event such as a received message, an appointment, a proximity notification, and the like without disturbing a user. The location manager 350 may manage location information of the electronic device. The graphic manager 351 may manage graphic effects to be provided to a user and user interfaces related to the graphic effects. The security manager 352 may provide various security functions required for system security or user authentication. According to an embodiment of the present disclosure, when the electronic device (for example, electronic device 101) includes a call function, the middleware 330 may further include a telephony manager for managing a voice call function or a video call function of the electronic device.

The middleware 330 may include a middleware module for forming a combination of various functions of the aforementioned components. The middleware 330 may provide a modules specialized for each type of OS to provide a differentiated function. In addition, a few existing components may be dynamically removed from the middleware 330, or new components may be added to the middleware 330.

The API 360 (for example, the API 145) is a set of programming functions, and a different configuration thereof may be provided according to an OS. For example, in the case of Android or iOS, one API set may be provided for each platform. In the case of Tizen, two or more API sets may be provided for each platform.

The applications 370 (for example, the applications 147) may include, for example, one or more applications which can provide functions such as a home 371, a dialer 372, a short message service (SMS)/multimedia message service (MMS) 373, an instant message (IM) 374, a browser 375, a camera 376, an alarm 377, contacts 378, a voice dialer 379, an email 380, a calendar 381, a media player 382, an album 383, a clock 384, health care (for example, measure exercise quantity or blood sugar), or environmental information (for example, atmospheric pressure, humidity, or temperature information).

According to an embodiment of the present disclosure, the applications 370 may include an application (hereinafter, referred to as an “information exchange application” for convenience of the description) supporting information exchange between the electronic device (for example, the electronic device 101) and external electronic devices (for example, the electronic devices 102 and 104). The information exchange application may include, for example, a notification relay application for transmitting predetermined information to the external electronic device, or a device management application for managing the external electronic device.

For example, the information exchange application may include a function of delivering, to the external electronic device (e.g., the electronic device 102 or 104), notification information generated by other applications (e.g., an SMS/MMS application, an email application, a health care application, an environmental information application, etc.) of the electronic device 101. Further, the information exchange application may receive notification information from, for example, an external electronic device and provide the received notification information to a user. For example, the device management application may manage (for example, install, delete, or update) at least one function of the external electronic device (for example, the electronic device 104) communicating with the electronic device (for example, a function of turning on/off the external electronic device itself (or some components) or a function of adjusting luminance (or a resolution) of the display), applications operating in the external electronic device, or services provided by the external electronic device (e.g., a call service and a message service).

According to an embodiment of the present disclosure, the applications 370 may include an application (for example, health management application) designated according to attributes (for example, attributes of the electronic device such as the type of electronic device which corresponds to a mobile medical device) of the external electronic device (for example, the electronic device 102 or 104). According to an embodiment of the present disclosure, the applications 370 may include an application received from the external electronic device (for example, the server 106, or the electronic device 102 or 104). According to an embodiment of the present disclosure, the applications 370 may include a preloaded application or a third party application which can be downloaded from the server. Names of the elements of the program module 310, according to the above-described embodiments of the present disclosure, may change depending on the type of OS.

According to various embodiments of the present disclosure, at least some of the program module 310 may be implemented in software, firmware, hardware, or a combination of two or more thereof. At least some of the programming module 310 may be implemented (for example, executed) by, for example, the processor (for example, the AP 210). At least some of the programming module 310 may include, for example, a module, a program, a routine, instructions, a process, or the like for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an application-specific integrated circuit (ASIC) chip, a field-programmable gate array (FPGA), and a programmable-logic device for performing operations which has been known or are to be developed hereinafter.

According to various embodiments of the present disclosure, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, stored in the memory 130.

The computer readable recoding medium may be stored in a hard disk, a floppy disk, magnetic media (for example, a magnetic tape), optical media (for example, a Compact Disc ROM (CD-ROM) and a DVD), magneto-optical media (for example, a floptical disk), a hardware device (for example, a ROM, a RAM, a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Various embodiments of the present disclosure disclosed herein are provided merely to easily describe technical details of the present disclosure and to help the understanding of the present disclosure, and are not intended to limit the scope of the present disclosure.

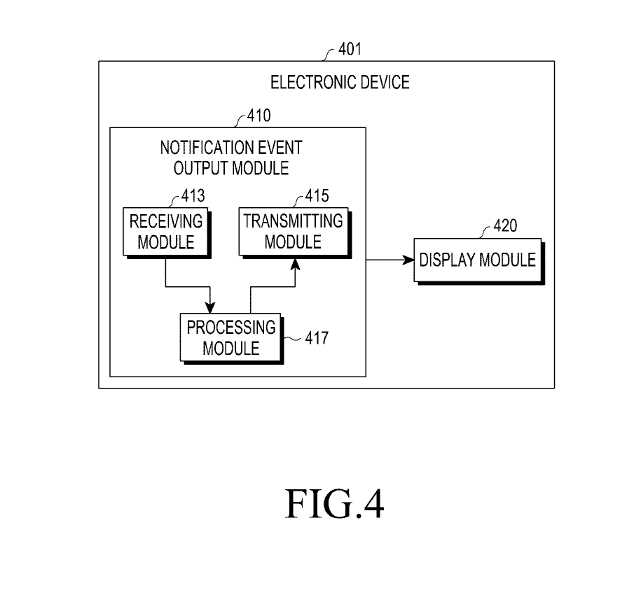

FIG. 4 is a block diagram of an electronic device for outputting a notification event according to various embodiments of the present disclosure.

Referring to FIG. 4, the electronic device 401 may include a notification event output module 410 implemented in, for example, the electronic device 101.

According to various embodiments of the present disclosure, the notification event output module 410 may include a receiving module 413, a transmitting module 415, and a processing module 417. According to an embodiment of the present disclosure, the notification event output module 410 may be the processor 120 shown in FIG. 1. The notification event output module 410, for example, may include hardware, software, firmware, or a combination thereof.

According to various embodiments of the present disclosure, the receiving module 413 may receive the notification event from an object, and may transmit the same to the processing module 417. The receiving module 413 may receive information provided by the object, and may transmit the same to the processing module 417. According to various embodiments of the present disclosure, the transmitting module 415 may transmit background information of the notification event to another electronic device. Another electronic device may be the electronic device 102 or 104 shown in FIG. 1. The background information, for example, may indicate background music, background colors, or background images.

According to various embodiments of the present disclosure, the processing module 417 may receive the notification event or the information, which is provided by the object, through the receiving module 413, and may output the background information of the notification event by using the information received from the object. According to various embodiments of the present disclosure, the object may be one or more applications included in the electronic device 401, or another electronic device that is connected with the electronic device 401.

According to various embodiments of the present disclosure, the processing module 417 may receive the notification event or application information provided by one or more applications through the receiving module 413, create attribute information based on the application information, and output the background information of the notification event based on the created attribute information. For example, the processing module 417 may output the background information to thereby display the received notification event.

The application information may represent features or the status of the application. For example, the application information may include at least one of an icon, a representative image, weather information, support OS information, language information, GPS information, the capacity, a production year, metadata, or application events that are provided during the execution of an application (e.g., input from a button, an interrupt, etc.) and recorded into, for example, a stack.

For example, if the application information includes the representative image or the icon, the processing module 417 may create the attribute information including the representative color or the pattern image, from the representative image or the icon. For example, if the application information includes language information or GPS information, the processing module 417 may create the attribute information including country information. For example, if the application information includes OS information that executes the application or that supports (operates) the application, the processing module 417 may create the attribute information including a brand or a specific sound of the OS. For example, if the attribute information corresponds to a lattice-pattern image, the processing module 417 may display the received notification event while outputting the lattice-pattern image as the background information of the notification event.

The notification event, which is provided from one or more applications, for example, may include at least one of a notification event that is created according to the reception of communication, such as an MMS, a social networking service (SNS), or an SMS, a notification event that is created by the configuration, such as a diary or an alarm, or a notification event that is created according to the services provided by communication providers or application providers.

The attribute information, for example, may include at least one of a color, a pattern, a gradation, a temperature, an altitude, a set of coordinates, or humidity information. In addition, the attribute information may include at least one of a font size, a symbol, a texture, a shape, a temperature, an odor (smell), a sound, a vibration, a flavor, wind, light, an altitude (height), a location coordinate a rotation, a speed, magnetism information, a current, a voltage, UV rays, radioactive rays, a gas, ions, a pressure, or an elasticity.

According to an embodiment of the present disclosure, the processing module 417 may create the attribute information based on the application information provided by one or more applications, and may determine the type of notification event based on the created attribute information. In addition, the processing module 417 may configure the background information of the notification event based on the determined type of notification event. In addition, the processing module 417 may display the received notification event while outputting the configured background information.

The type of notification event may be classified according to at least one of the attribute information, the application information, the priority predetermined by the user, the data contained in the notification event, the type of application, or information on the type of notification event that is predetermined by the application.

When the notification event is classified according to the attribute information, for example, if the attribute information is the altitude and the location coordinate, the processing module 417 may classify the type of notification event as a “location.”

When the notification event is classified according to the application information, for example, if the application information is weather information, the processing module 417 may classify the type of notification event as “weather.” When the notification event is classified according to the application information, the processing module 417 may classify the type of notification event through a combination of one or more pieces of the information contained in the application information. When the notification event is classified according to the application information, for example, if the application information includes clear GPS information as well as color information, the processing module 417 may classify the type of notification event as a “location.” When the notification event is classified according to the application information, for example, if the application information does not include the information for classifying the type of notification event, or if the application information includes only the representative image or icon, the processing module 417 may classify the type of notification event as “normal.”

When the notification event is classified according to the priority predetermined by the user, for example, if the priority is configured as “health>location>weather,” and if the attribute information is the temperature, the processing module 417 may classify the type of notification event as “health.”

When the notification event is classified according to the data contained in the notification event, for example, if the content of the notification event relates to sports as a result of processing the context of the content of the notification event, the processing module 417 may classify the type of notification event as “sports.” For example, if the content of the notification event includes “strike,” “hit,” or “throw,” the processing module 417 may classify the type of notification event as “sports” (baseball) as a result of the process of the context.

When the notification event is classified according to the type of application that provides the notification event, for example, if the type of application providing the notification event is a thermometer application, the processing module 417 may classify the type of notification event as “weather.”

According to an embodiment of the present disclosure, when the predetermined information on the type of notification event is detected in the notification event provided from the application, the processing module 417 may classify the type of notification event by using the detected type information of notification event.

For example, the application capable of creating various notification events may transmit various notification events that include the type information of a specific notification event to the processing module 417. For example, a single application may create a plurality of notification events that have different types, and may include a single piece of type information of the notification event in the plurality of notification events to then be transmitted to the processing module 417.

According to an embodiment of the present disclosure, the notification event may include the type information of the notification event or data. The type information of the notification event shows the type of notification event, and may be the information that is specified in the application. The data included in the notification event may include at least one of text, pictures, videos, or sounds.

If the received notification event includes the type information of notification event, the processing module 417 may classify the type of notification event based on the type information of the notification event. If the received notification event includes the data, the processing module 417 may process the data to correspond to the type of notification event to display with the notification event.

According to an embodiment of the present disclosure, the type of notification event may include normal, a special day, a sport, a connection, an OS, a location, a weather event, a temperature, and a health event. The type of notification event is not limited thereto, and various types of notification events may be added. Each type of notification event may be defined as a constant value that is predetermined to correspond thereto.

The processing module 417 may classify the type of notification event as a “special day” by using the attribute information of the application.

For example, in the case of the attribute information of colors, the processing module 417 may classify the type of notification event as normal, detect a color from the icon or the representative image of the application information, configure the detected color as the background information of the notification event, and display the notification event while outputting the detected color as the background color of the notification event. For example, when the notification event that informs of a posting in an SNS is received, the processing module 417 may detect a color as the attribute information from the icon that represents the Facebook application, and may display the notification event while outputting the detected color as the background color of the notification event.

For example, if two or more colors having values more than the reference value are detected from the icon or the representative image, the processing module 417 may display the notification event while outputting the detected two or more colors as the background color of the notification event.

For example, when the notification event is received from a browser application, the processing module 417 may detect colors of the icon included in the application information provided by the browser application, and if the representative color of the icon is a representative multi-color of red, blue, and yellow, the processing module 417 may display the notification event while outputting the image made by a combination of the colors as the background color of the notification event.

In addition, the processing module 417 may output the three colors as the background color of the notification event in sequence depending on the time to thereby display the notification event.

For example, when a specific pattern is detected from the icon or the representative image contained in the application information, the processing module 417 may display the notification event while outputting the specific pattern as the background color of the notification event. For example, when the notification event is received from the application that provides an image of a star-shaped pattern, the processing module 417 may detect the star-shaped pattern from the image included in the application information, and may display the notification event while outputting the star-shaped pattern as the background color of the notification event. The detection of the colors from the icon or the image may be carried out by using an extraction algorithm that will be described in detail below.

An image provided by the application may be obtained as a bitmap, and a color code of a single pixel is extracted from the original bitmap or the copy of the scaled bitmap in order to thereby obtain statistics. Based on the statistics, it is possible to configure a color code array type data structure A, which is stored at the highest frequency, and a two-dimensional array type data structure B for storing the color code for each index. Based on the data structure A, if a color code of the highest frequency has a frequency that is more than a specific multiple of the frequency of the color codes of low frequencies (second place, third place . . . ), the corresponding color code may be a single representative color, and the extraction algorithm may return the same. Based on the data structure A, if a color code of a highest frequency has a frequency that is not much different from frequencies of the color codes of low frequencies (second place, third place, etc.), the color code of the highest frequency and the color codes that have similar frequencies to the highest frequency may be multiple representative colors, and the extraction algorithm may return the same.

Based on the data structure B, if the same color code is repeated in every specific index, the index before the repetition may be obtained using a column and a row, and an image area to the index may be recognized as a pattern, so the extraction algorithm may return the image pattern that is cropped in part. The criteria for the comparison is not limited to the frequency, and it may include area, concentration, thickness, and volume, or it may follow the user's weight value or priority configuration. In addition, the criteria for the comparison may be a combination thereof. The extraction algorithm is shown as the details of an embodiment of the present disclosure, and another extraction algorithm that can detect the attribute information (colors or patterns) may be used.

The processing module 417 may classify the type of notification event as a “special day” by using the application information.

The processing module 417, for example, may configure the background information (e.g., background music, background colors, and background images) on the basis of the application information, output the background music (e.g., a happy birthday song, a wedding song, a graduation song, or the like) as the configured background information through an audio module, and display the notification event that includes a date, time, and data (e.g., text) while outputting the background color or the background image (e.g., anniversary pictures) through the display module 420. In addition, the processing module 417 may display the notification event while outputting a background combination that includes the background music, the background color, and the background image.

The processing module 417 may classify the type of notification event as a sport event by using the application information.

The processing module 417, for example, may receive the notification event that has been updated in real time with the status, such as scores of sporting events, by using the received application information.

The processing module 417, for example, may configure the background information (e.g., background music, background colors, and background images) on the basis of the application information, output the background music (e.g., specified cheering music, sports effect sounds, or the like) as the configured background information through the audio module, and display the notification event that includes a date, time, and data (e.g., text) while outputting the background color or the background image (e.g., team logos) through the display module 420. In addition, the processing module 417 may display the notification event while outputting a background combination that includes the background music, the background color, and the background image.

The processing module 417 may classify the type of notification event as OS information by using the application information.

The processing module 417, for example, may configure the background information (e.g., background music, background colors, and background images) on the basis of the application information, output the background music (e.g., background music of the OS, distinct effect sounds of the OS, or the like) as the configured background information through the audio module, and display the notification event that includes a date, time, and data (e.g., text) while outputting the background color or the background image (e.g., logos) through the display module 420. In addition, the processing module 417 may display the notification event while outputting a background combination that includes the background music, the background color, and the background image.

The processing module 417 may classify the type of notification event as a location event by using the application information.

The processing module 417, for example, may configure the background information (e.g., background music, background colors, and background images) on the basis of the application information, output the background music (e.g., a national anthem of the country to which the location belongs) as the configured background information through the audio module, and display the notification event that includes a date, time, and data (e.g., text) while outputting the background color or the background image (e.g., flags or map images) through the display module 420. In addition, the processing module 417, based on the weather in the corresponding location, status information of the corresponding location, or information obtained through a weather server, may output a corresponding temperature as the background temperature through a heat generator, and may output the corresponding humidity as the background humidity through a humidifier. In addition, the processing module 417 may output a background combination that includes the background music, the background color, and the background image to thereby display the notification event.

The processing module 417 may classify the type of notification event as a weather event by using the application information.

The processing module 417, for example, may configure the background information (e.g., background music, background colors, and background images) on the basis of the application information, output the background music (e.g., the sound of rain, the sound of wind, the sound of storm, the chirping of cicadas, or the water dripping sound as the configured background information through the audio module, and display the notification event that includes a date, time, and data (e.g., text) while outputting the background color or the background image (e.g., the season, flowers or trees of the season, sprouts, autumn leaves, or fallen leaves) through the display module 420. In addition, the processing module 417 may analyze date information or local information to identify the current weather or seasonal information, and may output a background scent according to the season (for example the scent of flowers for spring, the scent of a sea for summer, the scent of fallen leaves for fall, and the scent of water vapor for winter) through a scent generator. In addition, the processing module 417 may output the current information on wind direction or wind speed as the background wind through a wind generator. In addition, the processing module 417 may output a background combination that includes the background music, the background color, and the background image to thereby display the notification event.

The processing module 417 may classify the type of notification event as a connection event by using the application information.

The processing module 417, for example, may configure the background information (e.g., background music, background colors, and background images) on the basis of the application information. The processing module 417 may detect connection information based on the application information, and may configure the background information by using the connection information. The connection information, for example, may include at least one of the type of connection (e.g., wired connection, wireless connection, Wi-Fi, BT, NFC, a beacon, or the like), the connection status, the type of connected electronic, the location of the connected electronic device, the operation status of the connected electronic device, or the operation intensity and frequency of the connected electronic device. The processing module 417 may output the background music (e.g., the sound of a heartbeat in the case where the connected electronic device is positioned near the heart) as the configured background information through the audio module, and may display the notification event that includes a date, time, and data (e.g., text) while outputting the background color or the background image (e.g., the operation status of the connected electronic device (for example, gray in a power-off mode and a sleep mode, green in an operation mode, or red in the case of malfunction)) through the display module 420. In addition, the processing module 417 may output the operation intensity or frequency of the connected electronic device as the background vibration through a vibration generator. In addition, the processing module 417 may output a background combination that includes the background music, the background color, and the background image to thereby display the notification event.

The connected electronic device may include servers, wearable electronic devices, general electronic devices, home appliances, bio-electronic devices, or accessory electronic devices. The servers may provide services that include applications, cloud computing, speech recognition, text recognition, or image recognition. The wearable electronic devices may include watches, glasses, necklaces, or rings. The general electronic devices may include monitors, PCs, tablets, or smart phones. The home appliances may include washing machines, refrigerators, TV sets, or the like. The bio-electronic devices may be provided inside or outside the body to check the physical condition and to assist in bodily functions. The accessory electronic devices may include earphones, headsets, electronic pens, or electronic covers.

The processing module 417 may classify the type of notification event as a health event by using the application information.

The processing module 417, for example, may configure the background information (e.g., background music, background colors, and background images) on the basis of the application information, output the background music (e.g., an alarm sound to warn of the status of the body temperature) as the configured background information through the audio module, and display the notification event that includes a date, time, and data (e.g., text) while outputting the background color or the background image (e.g., colors or images that indicate the current health status) through the display module 420. In addition, the processing module 417 may output a background combination that includes the background music, the background color, and the background image to thereby display the notification event.

According to various embodiments of the present disclosure, the processing module 417 may create the attribute information based on the device information provided by the electronic device 401 and the application information through the receiving module 413. The processing module 417 may create the attribute information based on the device information or a combination thereof.

The device information may be information that shows the status of the electronic device 401, and may include at least one of, for example, communication information of the electronic device, location information of the electronic device, information provided by one or more sensors of the electronic device, or information provided by a server that is connected to the electronic device.

The communication information of the electronic device may include GPS information, cell network information, AP location information, or Internet of things (TOT) information, or may include a combination thereof.

The information provided by one or more sensors may include sensor information provided by one or more sensors (e.g., a barometer sensor, a humidity sensor, an altitude sensor, a UV sensor, a color sensor, an acceleration sensor, an earth-magnetic sensor, a bio-sensor, a bending sensor, or a transparency sensor), or may include a combination thereof.

The information provided by the server that is connected with the electronic device may include the status information (e.g., a current, overheating, on/off, operation, or the like) of the electronic device (e.g., home appliances, home devices, etc.) that is connected through the server (e.g., a home network).

According to various embodiments of the present disclosure, the processing module 417 may receive a notification event or external information that is provided by one or more other electronic devices (e.g., the second electronic device) connected with the electronic device 401 (e.g., the first electronic device), create the attribute information based on the external information, and output the background information of the notification event based on the created attribute information. The second electronic device may be the electronic device 102 or 104 shown in FIG. 1.

The external information may be provided from the second electronic device that is connected with the first electronic device, and may include connection information or status information.

The connection information may include the type of connection (e.g., at least one of wired connection, wireless connection, Wi-Fi, BT, or beacon), the connection status, the type of connected electronic device, the location of the connected electronic device, the operation status of the connected electronic device, or the operation intensity and frequency of the connected electronic device.

The processing module 417, for example, may configure the background information of the notification event on the basis of the connection information provided by the second electronic device, output the background music (e.g., the sound of a heartbeat in the case where the connected electronic device is positioned near the heart) as the configured background information through the audio module, and display the notification event that includes a date, time, and data (e.g., text) while outputting the background color or the background image (e.g., the operation status of the connected electronic device (for example, gray in a power-off mode and a sleep mode, green in an operation mode, or red in the case of malfunction)) through the display module 420. In addition, the processing module 417 may output the operation intensity or frequency of the connected second electronic device as the background vibration through a vibration generator. In addition, the processing module 417 may output the reception intensity or the reception frequency that is detected in the connected second electronic device (e.g., the intensity of a heartbeat or the frequency of a heartbeat that is detected in the second electronic device) as the background vibration through a vibration generator. In addition, the processing module 417 may output a background combination that includes the background music, the background color, and the background image to thereby display the notification event.

The status information may include at least one of the regional location, the physical position, weather, or user's status information (e.g., biometric information), which are recognized by the second electronic device or the third electronic device, as well as connection information of the third electronic device that is functionally connected to the second electronic device.

According to an embodiment of the present disclosure, when a notification event is received from the second electronic device, the processing module 417 may request to the second electronic device for external information or additional information f that is necessary for the creation of the attribute information. When the notification event is received from the third electronic device through the second electronic device, the processing module 417 may directly or indirectly request to the third electronic device directly or through the second electronic device for the external information or the additional information that is necessary for the creation of the attribute information.

According to an embodiment of the present disclosure, when a request for identifying the reception of the notification event is received from the second electronic device, the processing module 417 may configure the result of the reception identification of the notification event as the background information, and may transmit reception identification information of the notification event to the second electronic device. When a request for identifying the reception of the notification event is received from the third electronic device via the second electronic device, the processing module 417 may configure the result of the reception identification of the notification event as the background information, and may transmit reception identification information of the notification event to the third electronic device directly or through the second electronic device.

According to an embodiment of the present disclosure, the processing module 417 may transmit control commands, which are treated according to the content of the notification event, to the second electronic device. For example, in the case where the second electronic device is a wearable electronic device and the user uses a plurality of wearable electronic devices, when a notification event that informs of the abnormal operation of the second electronic device is received from the second electronic device, the processing module 417 may analyze the content of the notification event, and may transmit a control command that can provide a haptic feedback, a vibration feedback, a sound feedback, a smell feedback, or an optical (light) feedback to the second electronic device. When one or more operations of the haptic feedback, the vibration feedback, the sound feedback, the smell feedback, or the optical (light) feedback occur due to the control command, the user can intuitively recognize the location of the second electronic device.

According to an embodiment of the present disclosure, the processing module 417 may transmit control commands, which are treated according to the content of the notification event, to the third electronic device through the second electronic device. For example, in the case where the second electronic device is a home network electronic device and the second electronic device is connected with a plurality of home appliances, when a notification event that informs of the abnormal operation of the third electronic device is received from the second electronic device, the processing module 417 may analyze the content of the notification event, and may transmit a control command that can provide a haptic feedback, a vibration feedback, a sound feedback, a smell feedback, or an optical (light) feedback to the third electronic device through the second electronic device. When one or more operations of the haptic feedback, the vibration feedback, the sound feedback, the smell feedback, or the optical (light) feedback occur in the third electronic device according to the control command, the user may intuitively recognize the position of the third electronic device.

According to various embodiments of the present disclosure, if a notification event that is created by one or more application objects is transmitted to another electronic device (e.g., the second electronic device), the processing module 417 may transmit the background information of the notification event to the second electronic device.

According to an embodiment of the present disclosure, if it is identified that the notification event that is created by one or more applications has been transmitted to another electronic device (e.g., the second electronic device), the processing module 417 may create the attribute information based on the application information provided by one or more applications, and may configure the background information of the notification event based on the created attribute information. The processing module 417 may transmit the configured background information of the notification event to the second electronic device or the third electronic device connected with the second electronic device through the transmitting module 415.

According to an embodiment of the present disclosure, the processing module 417 may create one or more pieces of attribute information based on at least one piece of the application information provided by one or more applications, or the device information provided by the electronic device 401. When the attribute information is transmitted to the second electronic device or the third electronic device, the second electronic device or the third electronic device may configure the background information based on the attribute information, and may output the configured background information to thereby display the notification event that has been sent by the electronic device 401. When the attribute information is transmitted to the second electronic device or the third electronic device, the second electronic device or the third electronic device may configure the transmission status or the transmission result of the electronic device 401 as the background information, based on the attribute information, and may output the configured background information to thereby display the notification event that has been sent by the electronic device 401.

According to an embodiment of the present disclosure, if the transmission of the notification event to the second electronic device is identified, the processing module 417 may display the notification event that informs of the completion of the transmission while outputting the configured background information of the notification event as the background information of the notification event of the electronic device 401.

According to various embodiments of the present disclosure, the background information of the notification event may include a background screen, and the background screen may include at least one of a background color, a background pattern, or a background image.

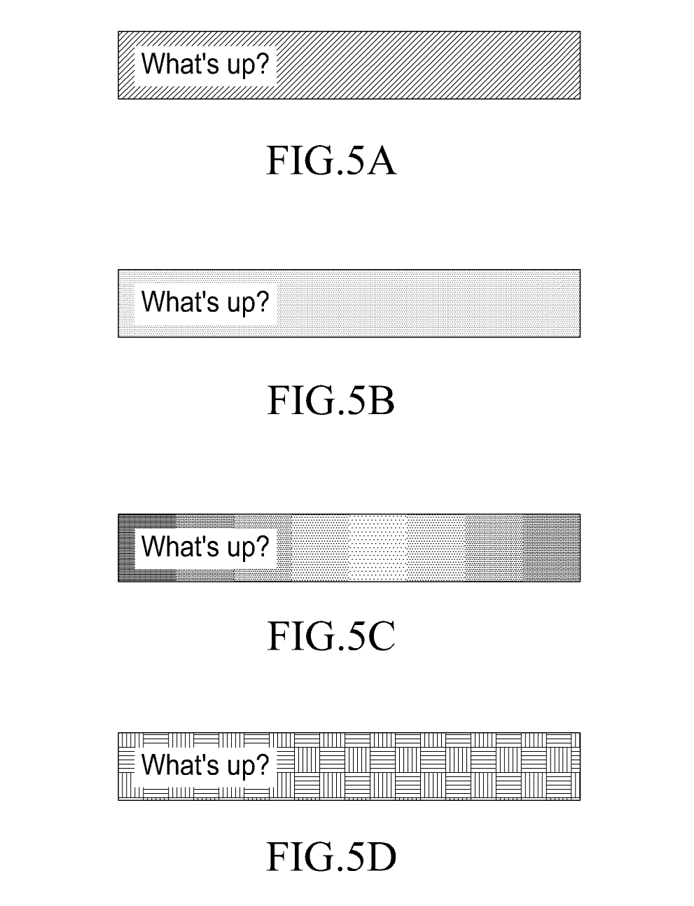

FIGS. 5A, 5B, 5C, and 5D illustrate examples of background images of a notification event according to various embodiments of the present disclosure.

Referring to FIGS. 5A, 5B, 5C, and 5D, the processing module 417, based on the attribute information, may display the background screen of the notification event in monochrome as shown in FIGS. 5A and 5B, in multiple colors or gradation as shown in FIG. 5C, or in a background pattern as shown in FIG. 5D.

According to various embodiments of the present disclosure, the processing module 417 may detect the status information of the notification event, and may configure the background information of the notification event based on the attribute information and the status information of the notification event. The status information may include at least one of the periodicity of the notification event, the transmission time of the notification event, the transmission location of the notification event, the type of data contained in the notification event, or the location of the electronic device.

The processing module 417 may detect the periodicity of the notification event by using the status information of the notification event. For example, in the case of a schedule-related notification event (e.g., an anniversary, a birthday, or graduation) that is to be created periodically, the processing module 417 may display the background screen of the notification event to be different by using a schedule set in the notification event to thereby allow the user to recognize how many days are left before the periodic deadline. For example, in the case of a schedule-related notification event (e.g., an anniversary, a birthday, or graduation) that is to be created periodically, the processing module 417 may calculate time on the basis of the schedule or the alarm creating date, and may output, as the background screen of the notification event, background images (for example, background effects, such as wrinkling, cracking, tearing, pollution and stains, oldness, rags, faded colors, or the like) that show that time passes to thereby allow the user to recognize how long ago the notification event was created.

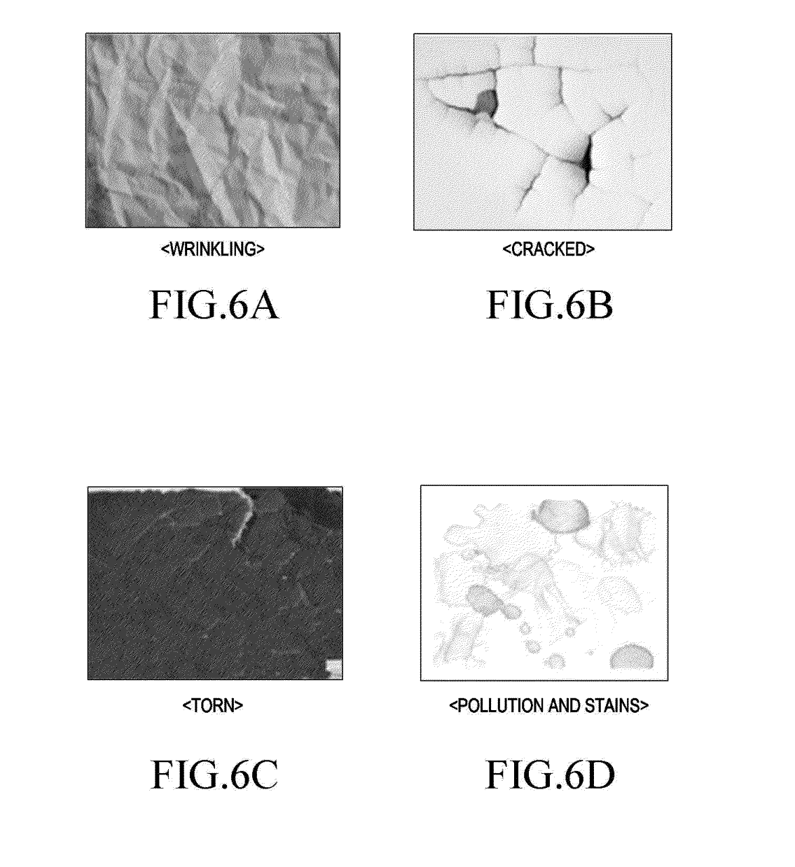

FIGS. 6A, 6B, 6C, and 6D illustrate examples of background effects of a notification event according to various embodiments of the present disclosure.

Referring to FIGS. 6A, 6B, 6C, and 6D, to show how long ago the notification event was created, the processing module 417 may display the background image of a wrinkling effect as shown in FIG. 6A, the background image of a cracking effect as shown in FIG. 6B, the background image of a tearing effect as shown in FIG. 6C, or the background image of a pollution or stain effect as shown in FIG. 6D.

The processing module 417 may detect the transmission time of the notification event by using the status information of the notification event, and the transmission time information of the notification event may be included in the notification event. For example, when the user of another electronic device (e.g., the second electronic device) transmits the notification event from overseas, the processing module 417 may configure the background screen of the notification event (for example, dark at night, and bright in the daytime) on the basis of the transmission time of the notification event in the second electronic device, and may output the same. In addition, the processing module 417 may output, as the background temperature, a temperature that corresponds to the season, the climate, or the temperature on the basis of the transmission time of the notification event in the second electronic device through a heat generator, or may output a humidity corresponding thereto as the background humidity through a humidifier.

The processing module 417 may detect the transmission location of the notification event by using the status information of the notification event, and the transmission location information of the notification event may be included in the notification event. If the electronic device includes a transparent display module, the processing module 417 may configure the background screen, of which the transparency is adjusted based on the attribute information, as the background information. The processing module 417 may dynamically configure the size or the background information of the notification event to be different. That is, the processing module 417 may configure the transparency of the background screen to be different depending on the distance between the electronic device 401 and another electronic device (e.g., the second electronic device) to which the notification event has been transmitted. The user of the electronic device 401 can recognize the location of the second electronic device through the background of the notification event.

The processing module 417 may detect the type of data contained in the notification event by using the status information of the notification event. For example, if the type of data contained in the notification event is text, the processing module 417 may configure, as the background sound, the audio output of the text of the notification event by using a text to speech (TTS) function based on the attribute information.

The processing module 417 may detect the current location of the electronic device 401 by using the status information of the notification event. For example, if the user of the electronic device 401 is climbing, the processing module 417 may configure, as the background information of the notification event, a background image that includes an altitude expressed in colors and contour lines according to the location of the user in climbing. In addition, the processing module 417 may configure, as the background information of the notification event, logical or physical image forms based on the attribute information.

If the electronic device 401 is a flexible electronic device, the processing module 417, for example, based on the attribute information, may configure the wrinkling of the electronic device as the background information, configure the wrinkling of the image as the background information, or configure the physical wrinkling as the background information by using a separate actuator. In addition, the processing module 417 may configure, as the background information, three-dimensional (3D) images (e.g., real 3D holograms, virtual 3D images—expressing 3D images in a two-dimensional (2D) screen) based on the attribute information. In addition, the processing module 417 may configure, as background information, a change in the shape of the electronic device based on the attribute information in a flexible electronic device including a physical actuator.

According to various embodiments of the present disclosure, while the processing module 417 outputs the background information that is configured based on the attribute information to thereby display the notification event, when the notification event is selected, the processing module 417 may perform the first operation of displaying the details of the notification event, and when the background of the notification event is selected, the processing module 417 may perform the second operation related to the notification event. For example, if the background of the notification event is selected while the processing module 417 outputs the background information that is configured based on the attribute information to thereby display the notification event, the processing module 417 may display the communication connection status or the type of communications with respect to another electronic device (e.g., the second electronic device) to which the notification event has been transmitted. In addition, when the background of the notification event is selected, if the communication connection with the second electronic device is disrupted, the processing module 417 may display the disruption of the communication connection. In addition, when the background of the notification event is selected, the processing module 417 may display other available communication means or a method of switching into other available communication means.

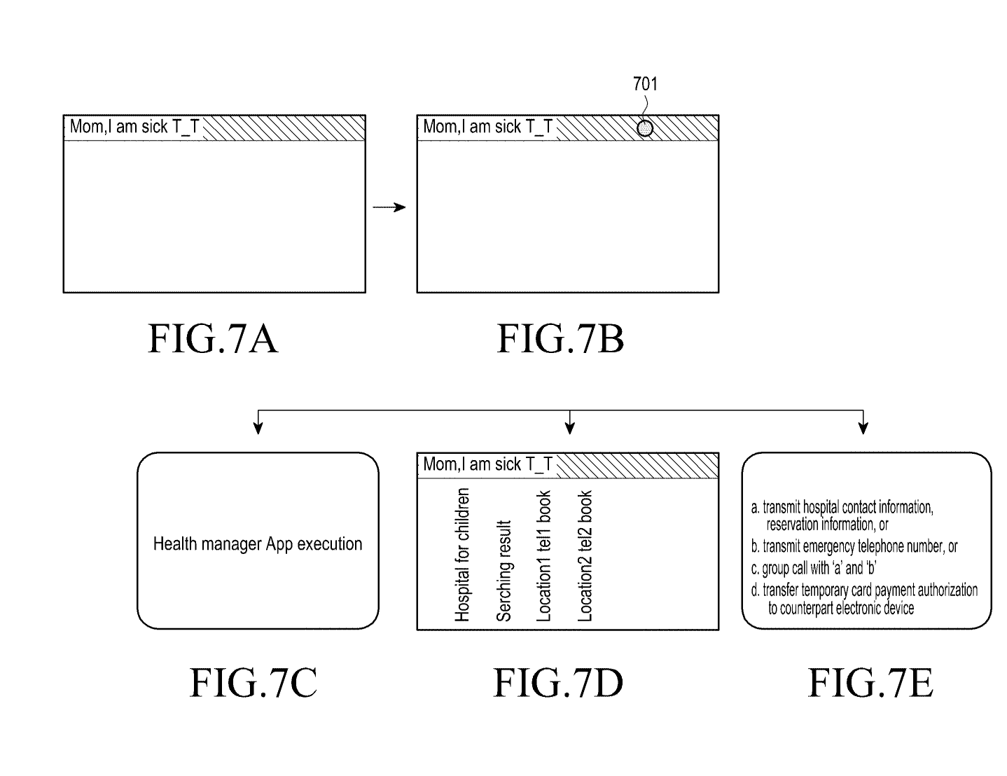

FIGS. 7A, 7B, 7C, 7D, 7E, 8A, 8B, 8C, 8D, 8E, 9A, 9B, 9C, 9D, to and 9E illustrate examples of control operations of a background screen of a notification event according to various embodiments of the present disclosure.

Referring to FIG. 7A, when a notification event, such as text, is received from the electronic device of the child, the processing module 417 may configure, as the background information, a background color, by which the user can intuitively recognize the child's body temperature, based on the attribute information including the temperature information or the content of the notification event (“Mom, I am sick”), and may display the notification event while outputting the configured background information. Referring to FIGS. 7B, 7C, 7D, and 7E, if the background of the notification event is selected at operation 701 while outputting the configured background information to display the notification event as shown in FIG. 7B, the processing module 417 may execute a health-related application as shown in FIG. 7C, display the hospital information searched based on the current location of the child as shown in FIG. 7D, or transmit related contact information or authority information necessary for using services (for example, a temporary transfer of card payment authorization) to the electronic device of the child as shown in FIG. 7E.

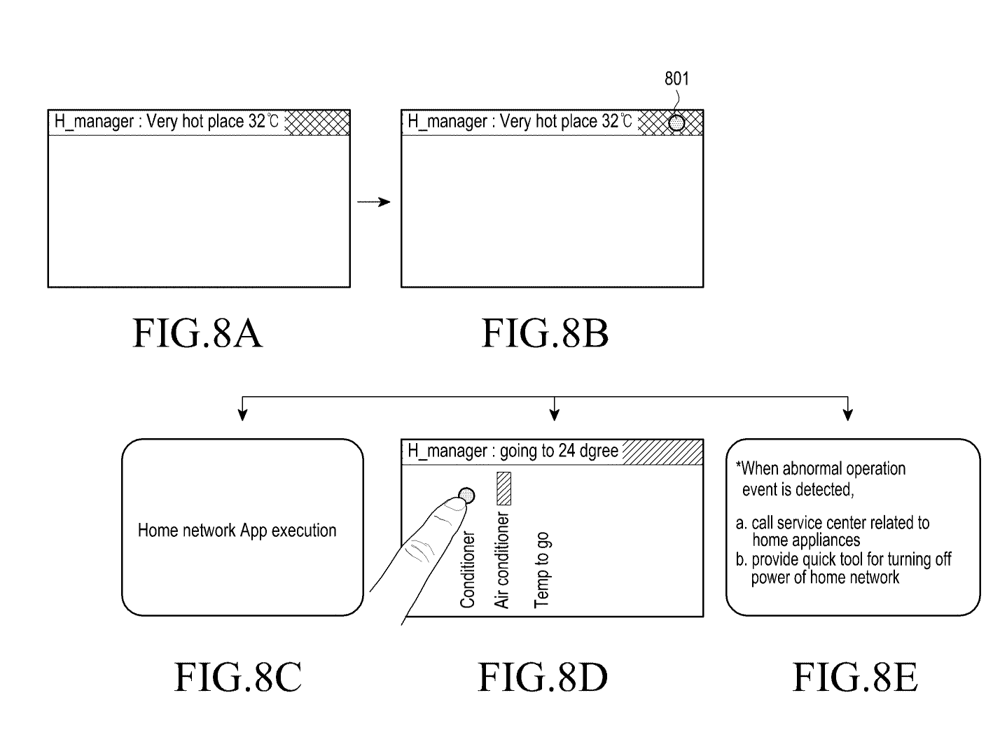

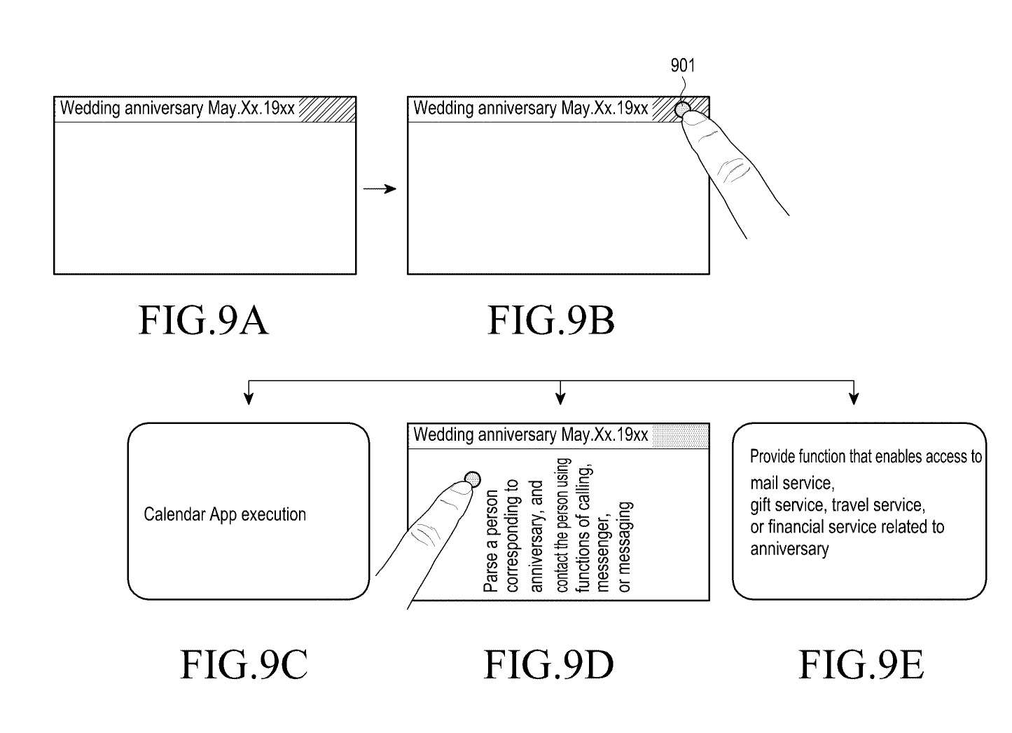

Referring to FIG. 8A, a notification event informing of the home temperature is received from a home network electronic device as shown in FIG. 8A, the processing module 417 may configure, as the background information, a background color, by which the user can intuitively recognize the home temperature status, based on the attribute information including the temperature information, and may display qualitative information or quantitative information through the notification event related to the operation of a boiler while outputting the configured background information. The processing module 417 may display, as the background information of the notification event, the operation status (for example, green in the power-on status, gray in the power-off status, a dynamic change in colors in the operation status, or red in the malfunction status) of the home electronic device (e.g., a boiler), and may display, as the content of the notification event, the type of corresponding home electronic device and the malfunction information thereof. Referring to FIGS. 8B, 8C, 8D, and 8E, if the background of the notification event is selected at operation 801 while outputting the configured background information to display the notification event as shown in FIG. 8B, the processing module 417 may execute a home network application as shown in FIG. 8C; display a menu for adjusting the home temperature as shown in FIG. 8D; or, if the home temperature is detected to be abnormal, display telephone numbers related to services of the home electronic device or provide a quick tool for turning off the power of the home network as shown in FIG. 8E. Referring to FIG. 9A, when a notification event informing of the anniversary is received from the calendar application as shown in FIG. 9A, the processing module 417 may configure the background information based on the attribute information, and may output the configured background information to thereby display the notification event. The processing module 417, for example, may configure the background information using the background color based on the creation date of the notification event or the elapse of time to allow the user to intuitively recognize the elapse of time. Referring to FIGS. 9B, 9C, 9D, and 9E, if the background of the notification event is selected at operation 901 while outputting the configured background information to display the notification event as shown in FIG. 9B, the processing module 417 may execute the schedule-related application as shown in FIG. 9C, detect a person corresponding to the anniversary and display functions of contacting the person as shown in FIG. 9D, or display services related to the anniversary as shown in FIG. 9E. If the background of the notification event is selected while outputting the background information, the processing module 417 may transmit a control command for performing the feedback operation to another electronic device that is functionally connected with the electronic device 401. For example, in the case where another electronic device functionally connected with the electronic device 401 is a wearable electronic device and the processing module 417 displays a notification event received from the wearable electronic device, when the background of the notification event is selected, the processing module 417 may transmit a control command for operating the vibration feedback of the wearable electronic device. In addition, in the case where the processing module 417 displays a notification event received from the wearable electronic device, when the background of the notification event is selected, the processing module 417 may transmit a control command to allow the electronic device 401 to perform an effective physical detecting operation or an effective chemical detecting operation with respect to the wearable electronic device according to the current status of the electronic device 401 or the content of the notification event.

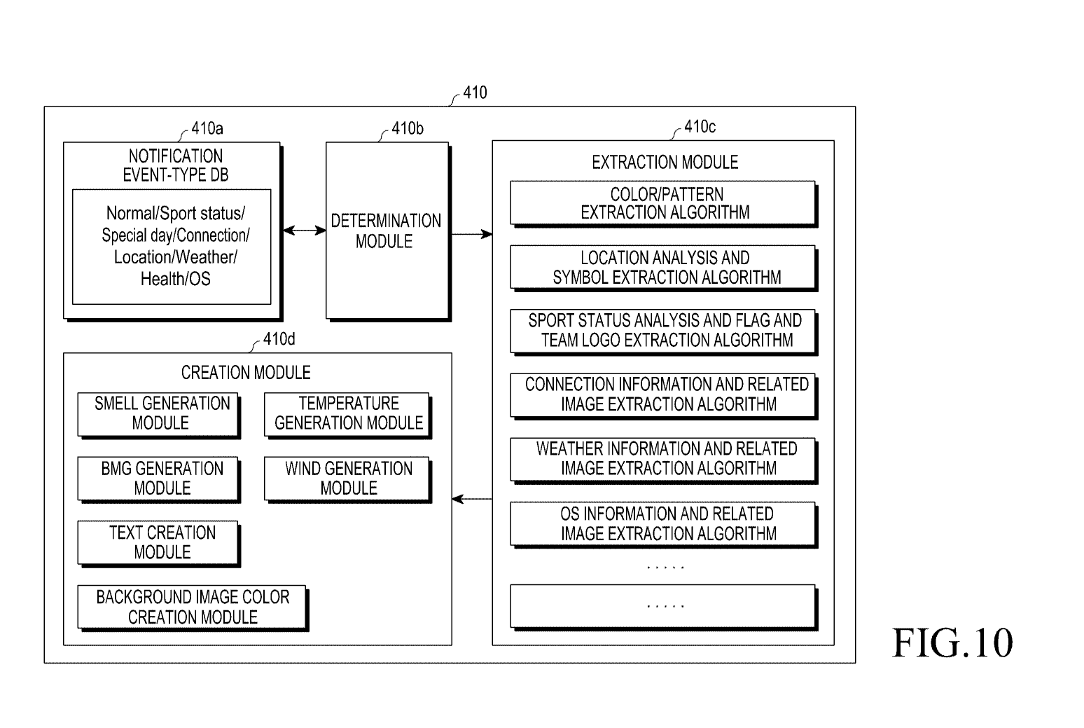

FIG. 10 is a block diagram of a processing module according to various embodiments of the present disclosure.

Referring to FIG. 10, according to an embodiment of the present disclosure, the processing module 410 may include a notification event-type database (DB) 410a, a determination module 410b, an extraction module 410c, and a creation module 410d. The notification event-type DB 410a may store the type of notification event and the information on the type of notification event. The determination module 410b may determine the type of notification event to correspond to the attribute information that is created by the reception or transmission of the notification event from the notification event-type DB 410a, and may transmit the determined information about the type of notification event to the extraction module 410c. In addition, the determination module 410b may transmit the attribute information that is created by the reception or transmission of the notification event to the extraction module 410c. The extraction module 410c may include various extraction algorithms, and may extract the data required for the configuration of the background information from the first information provided by the object or the second information provided by the electronic device, according to the attribute information or the type of notification event received from the determination module 410b to thereby transmit the same to the creation module 410d. The creation module 410d may include various creation modules, and when the data is received from the extraction module 410c, may output the background information of the notification event by using a creation module corresponding to the type of the received data. For example, if the type of notification event received through the notification event-type DB 410a is determined to be a normal event, the determination module 410b may transmit the information stating that the type of notification event is a normal event to the extraction module 410c. The extraction module 410c may extract a color or a pattern from the icon or the representative image included in the first information that is provided by the object by using a color/pattern extraction algorithm among the various extraction algorithms, and may transmit the same to the creation module 410d. When the extracted color or pattern is received from the extraction module 410c, the creation module 410d may output the extracted color or pattern as the background color or the background pattern by using a background image/color creation module among the various creation modules.

The display module 420 may be, for example, the display 160 shown in FIG. 1. According to an embodiment of the present disclosure, the display module 420 may output background information that is configured based on the attribute information of the notification event, i.e., at least one of, for example, the background color, the background pattern, or the background image to thereby display the notification event.

According to various embodiments of the present disclosure, the receiving module 413 may be configured to receive the notification event from the object, and the processing module 417 may be configured to identify the reception of the notification event, create the attribute information based on the information provided by the object, configure the background information of the notification event by using the attribute information, and output the configured background information of the notification event.

According to various embodiments of the present disclosure, the processing module 417 may be configured to display the notification event while outputting the configured background information of the notification event.

According to various embodiments of the present disclosure, the object may include one or more applications that are included in the electronic device, and application information, which is provided by the application, may include at least one of an icon, a representative image, weather information, support OS information, language information, GPS information, the capacity, a production year, metadata, or application events.

According to various embodiments of the present disclosure, the object may include another electronic device that is functionally connected with the electronic device, and external information, which is provided by the other electronic device, may include connection information of the another electronic device.

According to various embodiments of the present disclosure, the processing module 417 may be configured to determine the type of notification event by using the attribute information, and to configure the background information of the notification event to correspond to the determined type of notification event.

According to various embodiments of the present disclosure, the processing module 417 may be configured to detect status information of the notification event and to configure the background information of the notification event based on the status information of the notification event, and the status information may include at least one of the periodicity of the notification event, the transmission time of the notification event, the transmission location of the notification event, the type of data contained in the notification event, or the location of the electronic device.

According to various embodiments of the present disclosure, the processing module 417 may be configured, while the configured background information of the notification event is output to display the notification event, if the background of the notification event is selected, to perform the second operation related to the notification event.

According to various embodiments of the present disclosure, the processing module 417 may be configured to transmit the background information to another electronic device so that the background information is displayed through the other electronic device that is functionally connected with the electronic device.

According to various embodiments of the present disclosure, the display module 420 may output one or more images, and the processor 120 may be functionally connected with the display, and may be configured to identify a notification event for one or more applications that can be executed in the electronic device, to obtain at least one piece of attribute information corresponding to the one or more applications or environment information of the electronic device based on the notification event, if the at least one piece of information is application information, to output the first image as the one or more images, and if the at least one piece of information is device information, to output the second image as the one or more images.

According to various embodiments of the present disclosure, the processor 120 may be configured, if it is identified that a color corresponding to the one or more applications as the attribute information is the first color, to output, as the first image, an image that has the first background color that is determined based on the first color, and if it is identified that a color corresponding to the one or more applications as the attribute information is the second color, to output, as the second image, an image that has the second background color that is determined based on the second color.

According to various embodiments of the present disclosure, the environment information may include information about at least one of temperature, humidity, or wind direction of the region where the electronic device is located.

According to various embodiments of the present disclosure, the processor 120 may be configured, if the temperature, the humidity, or the wind direction corresponds to the first temperature, the first humidity, or the first wind direction, respectively, to output an image that has the first color or the first texture as the first image, and, if the temperature, the humidity, or the wind direction corresponds to the second temperature, the second humidity, or the second wind direction, respectively, to output an image that has the second color or the second texture as the second image.

According to various embodiments of the present disclosure, the processor 120 may be configured to provide a notification corresponding to the notification event by using one or more output devices that are functionally connected with the electronic device, based on the at least one piece of information.

According to various embodiments of the present disclosure, the one or more output devices may include at least one of a scent generator, a vibration generator, a wind generator, or an audio device.

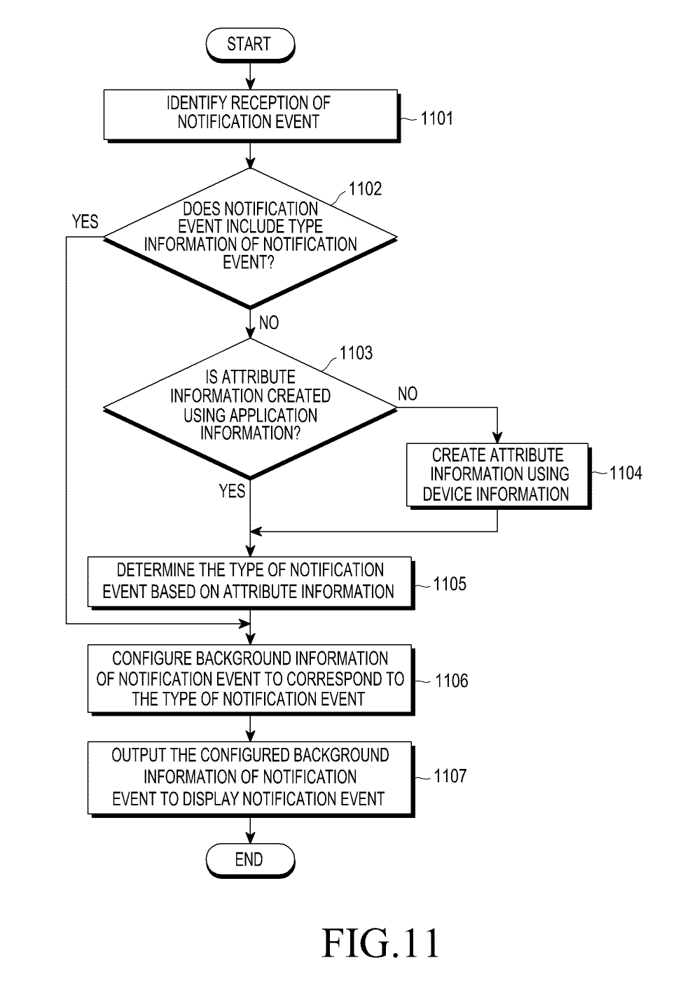

FIG. 11 is a flowchart of a method for outputting a notification event based on reception of a notification event according to various embodiments of the present disclosure.

Referring to FIG. 11, the notification event output method, according to various embodiments of the present disclosure, may include operations 1101 to 1107. In operation 1101, the processing module 417 may identify the reception of the notification event provided by the object (e.g., applications or other electronic devices) through the receiving module 413. In operation 1102, the processing module 417 may determine whether or not the notification event includes the information on the type of notification event, which is specified by the object. If the processing module 417 detects the information on the type of notification event from the received notification event in operation 1102, the processing module 417 may configure the background information of the notification event to correspond to the type of notification event in operation 1106. If the processing module 417 is not able to detect the information on the type of notification event from the received notification event in operation 1102, the processing module 417 may create the attribute information, based on the information (e.g., application information or external information) provided by the object, which is received through the receiving module 413. If the object is at least one application provided in the electronic device 401, the application information provided by the at least one application may include at least one of an icon, a representative image, weather information, support OS information, language information, GPS information, the capacity, a production year, metadata, or application events. If the object is another electronic device that is functionally connected with the electronic device 401, the external information provided by the another electronic device may include the connection information about the another electronic device, and the connection information may include at least one of the type of connection (e.g., at least one of wired connection, wireless connection, Wi-Fi, BT, or beacon), the connection status, the type of connected electronic device, the location of the connected electronic device, the operation status of the connected electronic device, or the operation intensity and frequency of the connected electronic device.

If the attribute information is created based on the information (e.g., application information or external information) provided by the object in operation 1103, the processing module 417 may determine the type of notification event based on the created attribute information in operation 1105, and may configure the background information of the notification event to correspond to the determined type of notification event in operation 1106. If the attribute information is created based on the information (e.g., application information or external information) provided by the object in operation 1103, the processing module 417 may configure the background information of the notification event based on the created attribute information without the type of notification event. If the object does not provide the information (e.g., application information or external information) or the attribute information is not created by using the information provided by the object in operation 1103, the processing module 417 may create the attribute information by using the device information provided by the electronic device 401 in operation 1104. The device information may include at least one piece of the communication information of the electronic device, the information provided by one or more sensors adopted by the electronic device, or the information provided by the server that is connected with the electronic device. The processing module 417 may create the attribute information by a combination of the information (e.g., application information or external information) provided by the object and the device information provided by the electronic device. If the attribute information is created based on the device information provided by the electronic device 401 in operation 1104, the processing module 417 may determine the type of notification event on the basis of the created attribute information in operation 1105, and may configure the background information of the notification event to correspond to the determined type of notification event in operation 1106. If the attribute information is created based on the device information provided by the electronic device 401 in operation 1104, the processing module 417 may configure the background information of the notification event based on the created attribute information without the determination of the type of notification event.

In operation 1107, the processing module 417 may display the notification event while outputting the configured background information of the notification event in a predetermined area of the display module 420.

The processing module 417 may output, using the method illustrated in FIG. 11, the background information of the notification event by which the user can intuitively recognize the type of notification event or the type of object that provides the notification event.

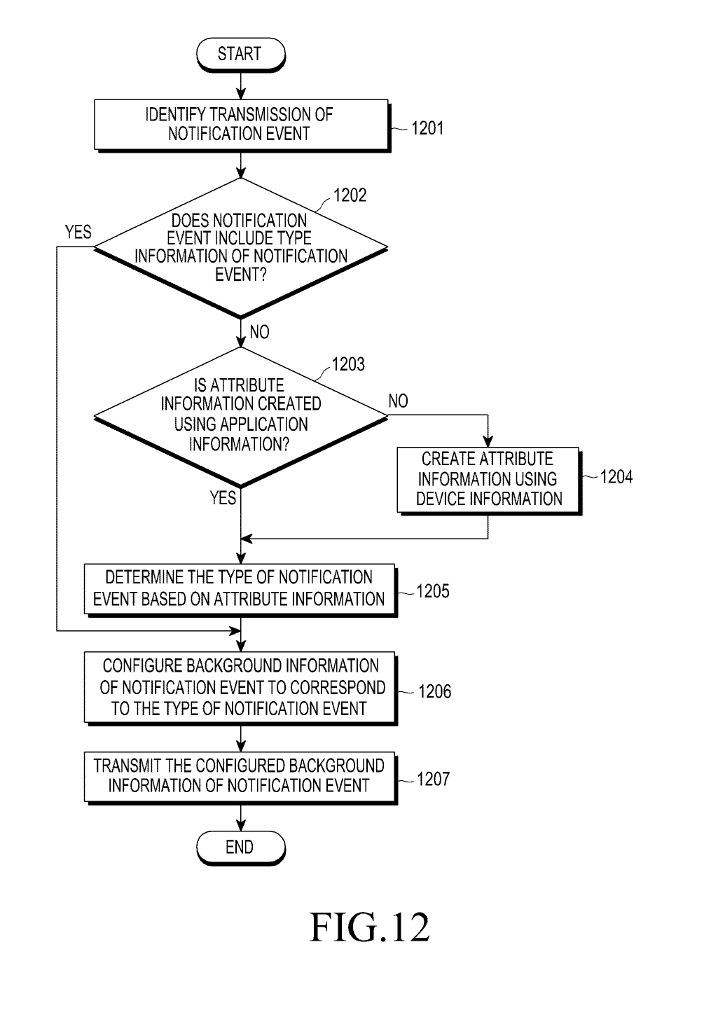

FIG. 12 is a flowchart of a method for outputting a notification event based on transmission of a notification event according to various embodiments of the present disclosure.

Referring to FIG. 12, the notification event output method 1200, according to various embodiments of the present disclosure, may include operations 1201 to 1207. In operation 1201, the processing module 417 may identify the transmission of the notification event created by the object (e.g., applications). In operation 1202, the processing module 417 may determine whether or not the transmitted notification event includes the information on the type of notification event, which is specified by the object. If the processing module 417 detects the information on the type of notification event from the transmitted notification event in operation 1202, the processing module 417 may configure the background information of the notification event to correspond to the type of notification event in operation 1206. If the processing module 417 is not able to detect the information on the type of notification event from the transmitted notification event in operation 1202, the processing module 417 may create the attribute information in operation 1203, based on the information (e.g., application information) provided by the object, which is received through the receiving module 413. The information (e.g., the application information) may include at least one of an icon, a representative image, weather information, support OS information, language information, GPS information, the capacity, a production year, metadata, or application events.

If the attribute information is created based on the information (e.g., application information) provided by the object in operation 1203, the processing module 417 may determine the type of notification event on the basis of the created attribute information in operation 1205, and may configure the background information of the notification event to correspond to the determined type of notification event in operation 1206. If the attribute information is created based on the information (e.g., application information) provided by the object in operation 1203, the processing module 417 may configure the background information of the notification event based on the created attribute information without the determination of the type of notification event. If the object does not provide the information (e.g., application information) or the attribute information is not created by using the information provided by the object in operation 1203, the processing module 417 may create the attribute information by using the device information provided by the electronic device 401 in operation 1204. The device information may include at least one piece of the communication information of the electronic device, information provided by one or more sensors of the electronic device, or the information provided by the server that is connected with the electronic device. The processing module 417 may create the attribute information by a combination of the information (e.g., application information) provided by the object and the device information provided by the electronic device. If the attribute information is created based on the device information provided by the electronic device 401 in operation 1204, the processing module 417 may determine the type of notification event on the basis of the created attribute information in operation 1205, and may configure the background information of the notification event to correspond to the determined type of notification event in operation 1206. If the attribute information is created based on the device information provided by the electronic device 401 in operation 1204, the processing module 417 may configure the background information of the notification event based on the created attribute information without the determination of the type of notification event.

In operation 1207, when the processing module 417 transmits the configured background information of the notification event to the counterpart electronic device to which the notification event has been transmitted and the counterpart electronic device displays the notification event, the processing module 417 may allow the counterpart electronic device to display the notification event while outputting the transmitted background information of the notification event. The processing module 417 may transmit the configured background information of the notification event to the counterpart electronic device to which the notification event has been transmitted, and may display the notification event that informs of the completion of the transmission while outputting the configured background information of the notification event in a predetermined area of the display module 420.

By using the method illustrated in FIG. 12, the processing module 417 may transmit, to another electronic device, the background information of the notification event by which the user can intuitively recognize the type of notification event or the type of object that provides the notification event, as well as the notification event.

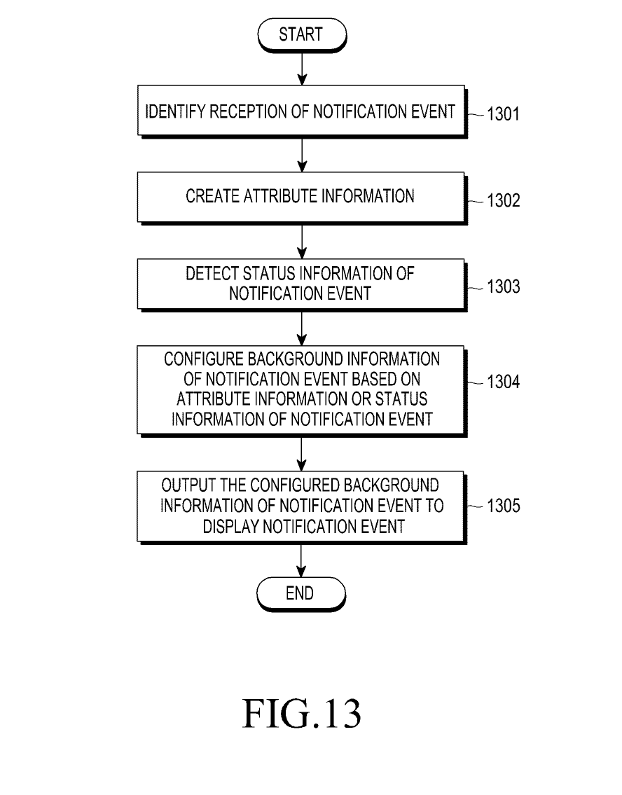

FIG. 13 is a flowchart of a method for outputting a notification event based on status information of a notification event according to various embodiments of the present disclosure.

Referring to FIG. 13, the notification event output method, according to various embodiments of the present disclosure, may include operations 1301 to 1305. In operation 1301, the processing module 417 may identify the reception of the notification event provided by the object (e.g., applications or other electronic devices) through the receiving module 413. In operation 1302, the processing module 417 may create the attribute information by using at least one piece of the information on the type of notification event contained in the notification event, the information (e.g., application information or external information) provided by the object, or the device information provided by the electronic device 401. In operation 1303, the processing module 417 may detect the status information of the received notification event. The status information of the notification event may include at least one of the periodicity of the notification event, the transmission time of the notification event, the transmission location of the notification event, the type of data contained in the notification event, or the location of the electronic device. In operation 1304, the processing module 417 may configure the background information of the notification event based on the created attribute information and the detected status information of the notification event. In operation 1305, the processing module 417 may output the background information of the notification event in a predetermined area of the display module 420 to thereby display the notification event.

By using the method illustrated in FIG. 13, the processing module 417 may output the background information of the notification event by which the user can intuitively recognize the type of notification event, the type of object that provides the notification event, or the notification event status (e.g., the periodicity of the notification event, the transmission time of the notification event, the transmission location of the notification event, the type of data contained in the notification event, or the current location of the electronic device that receives the notification event).

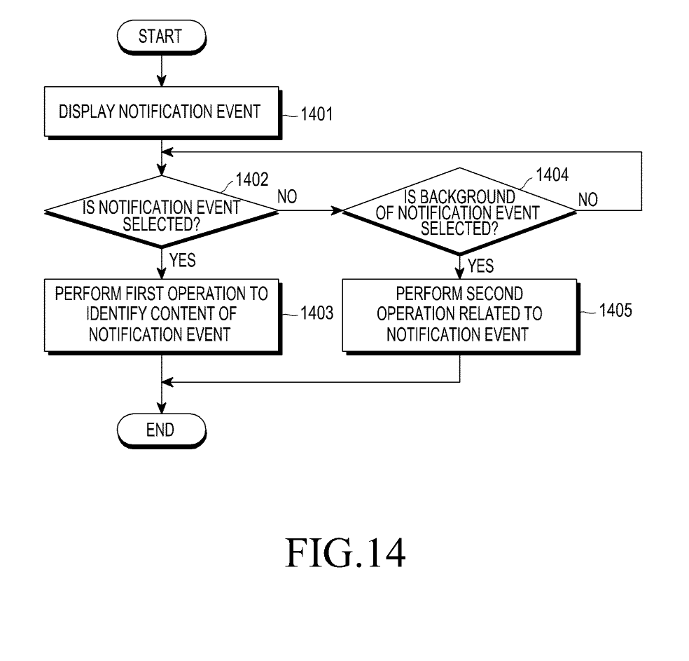

FIG. 14 is a flowchart of a method for outputting a notification event based on selection of a notification event according to various embodiments of the present disclosure.

Referring to FIG. 14, the notification event output method, according to various embodiments of the present disclosure, may include operations 1401 to 1405. In operation 1401, the processing module 417 may display the received notification event. In operation 1401, the processing module 417 may display the notification event while outputting the background information of the notification event that is created based on the created attribute information by using at least one piece of information on the type of notification event contained in the notification event, the information (e.g., application information or external information) that is provided by the object, or the device information that is provided by the electronic device 401. While the notification event is displayed, if it is determined that the notification event is selected in operation 1402, the processing module 417 may perform the first operation of identifying the details of the notification event in operation 1403. While the notification event is displayed, if it is determined that the background of the notification event is selected in operation 1404, the processing module 417 may perform the second operation that is related to the notification event in operation 1405. The second operation related to the notification event may include at least one operation of displaying the communication status between the electronic device 401 and another electronic device, displaying the type of another communication device that is available, displaying the information that can be provided to another electronic device to which the notification event has been transmitted, displaying the information that can control another electronic device to which the notification event has been transmitted, or displaying service information that is related to the notification event. The second operation related to the notification event may include a variety of functions according to the type of notification event. The processing module 417 may perform functions related to the notification event through the selection of the background of the notification event by using the method illustrated in FIG. 14.

According to various embodiments of the present disclosure, a method of outputting a notification event in an electronic device may include receiving the notification event from an object that is related to the electronic device, identifying attribute information corresponding to the object based on the receipt of the notification event, and outputting background information of the notification event by using the attribute information through an output device that is functionally connected with the electronic device.

According to various embodiments of the present disclosure, the operation of outputting may include displaying the notification event in relation to the background information.

According to various embodiments of the present disclosure, the object may include one or more applications that are included in the electronic device, or another electronic device that is functionally connected with the electronic device.

According to various embodiments of the present disclosure, the operation of outputting may include determining the type of notification event by using the attribute information, and configuring the background information of the notification event to correspond to the type of notification event.

According to various embodiments of the present disclosure, the operation of outputting may include performing an operation related to the notification event based on the output of the background information.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a receiving module configured to receive a notification event from an object; and
a processor configured to:
identify the reception of the notification event,
create attribute information based on the information provided by the object,
configure background information of the notification event by using the attribute information, and
output the background information of the notification event.

2. The electronic device of claim 1, wherein the processor is further configured to display the notification event while outputting the background information of the notification event.

3. The electronic device of claim 1,
wherein the object includes one or more applications that are included in the electronic device and application information provided by the application,
wherein the application information includes at least one of an icon, a representative image, weather information, support operating system (OS) information, language information, global positioning system (GPS) information, the capacity, a production year, metadata, or application events.

4. The electronic device of claim 1,
wherein the object includes another electronic device that is functionally connected with the electronic device, and external information, which is provided by the other electronic device,
wherein the external information includes connection information of the other electronic device.

5. The electronic device of claim 1, wherein the processor is further configured to:
determine the type of notification event based on the attribute information, and
configure the background information of the notification event to correspond to the determined type of notification event.

6. The electronic device of claim 1, wherein the processor is further configured to:
detect status information of the notification event, and
configure the background information of the notification event based on attribute information and the status information of the notification event, and
wherein the status information includes at least one of a periodicity of the notification event, a transmission time of the notification event, a transmission location of the notification event, a type of data contained in the notification event, or a location of the electronic device.

7. The electronic device of claim 1, wherein the processor is further configured to, while the background information of the notification event is output to display the notification event, if the background of the notification event is selected, perform the second operation related to the notification event.

8. The electronic device of claim 1, wherein the processor is further configured to transmit the background information to another electronic device so that the background information is displayed through the other electronic device.

9. A method of outputting a notification event in an electronic device, the method comprising:
receiving the notification event from an object that is related to the electronic device;
identifying attribute information corresponding to the object based on the receipt of the notification event; and
outputting background information of the notification event by using the attribute information through an output device that is functionally connected with the electronic device.

10. The method of claim 9, wherein the outputting of the background information comprises displaying the notification event in relation to the background information.

11. The method of claim 9, wherein the object includes one or more applications that are included in the electronic device, or another electronic device that is functionally connected with the electronic device.

12. The method of claim 9, wherein the outputting of the background information comprises:
determining the type of notification event based on the attribute information; and
configuring the background information of the notification event to correspond to the type of notification event.

13. The method of claim 9, wherein the outputting of the background information comprises performing an operation related to the notification event based on the output of the background information.

14. An electronic device comprising:
a display; and
a processor that is functionally connected with the display, and that is configured to:
identify a notification event for one or more applications that can be executed in the electronic device,
obtain at least one piece of attribute information corresponding to the one or more applications or environment information of the electronic device based on the notification event,
if the at least one piece of information is application information, output the first image via the display, and
if the at least one piece of information is device information, output the second image via the display.

15. The electronic device of claim 14, wherein the processor is further configured to:
if it is identified that a color corresponding to the one or more applications as the attribute information is the first color, output, as the first image, an image that has the first background color that is determined based on the first color, and
if it is identified that a color corresponding to the one or more applications as the attribute information is the second color, output, as the second image, an image that has the second background color that is determined based on the second color.

16. The electronic device of claim 14, wherein the environment information includes information about at least one of temperature, humidity, and wind direction of the region where the electronic device is located.

17. The electronic device of claim 16, wherein the processor is further configured to:
if the temperature, the humidity, or the wind direction corresponds to the first temperature, the first humidity, or the first wind direction, respectively, output an image that has the first color or the first texture as the first image, and
if the temperature, the humidity, or the wind direction corresponds to the second temperature, the second humidity, or the second wind direction, respectively, output an image that has the second color or the second texture as the second image.

18. The electronic device of claim 14, wherein the processor is further configured to provide the notification corresponding to the notification event by using one or more output devices that are functionally connected with the electronic device, based on the at least one piece of information.

19. The electronic device of claim 18, wherein the one or more output devices include at least one of a scent generator, a vibration generator, a wind generator, or an audio device.
